(19) United States
(12) Patent Application Publication
(10) Pub. No.: US 2022/0009075 A1
(43) Pub. Date: Jan. 13, 2022

(54) HANDHELD POWER TOOL AND SIDE HANDLE

(71) Applicant: Hilti Aktiengesellschaft, Schaan (LI)

(72) Inventors: Ali SCHAD, Muenchen (DE); Quirin WAHLE, Jengen (DE)

(21) Appl. No.: 17/295,973

(22) PCT Filed: Nov. 26, 2019
(86) PCT No.: PCT/EP2019/082574

§ 371 Date: May 21, 2021

(30) Foreign Application Priority Data
Dec. 17, 2018 (EP) 18212983.3

(51) Int. Cl. B25F 5/02; B25D 17/04

(52) U.S. Cl. CPC B25F 5/026; B25D 17/04; B25D 2250/361; B25D 2250/121; B25D 2250/051

(57) ABSTRACT

A tool unit including a handheld power tool and a side handle mechanically connected to the power tool, wherein the side handle has a threaded rod. The power tool has an undercut groove delimited by a groove bottom, and the side handle has a channel nut engaging the undercut groove, wherein the channel nut has a threaded hole, wherein the threaded rod of the side handle is threadedly engaged in the threaded hole of the channel nut and acts against the groove bottom of the undercut groove. Side handles and power tools for use in such a tool unit are also provided.

The invention relates to a tool unit comprising a handheld power tool and a side handle mechanically connected to the power tool, to a handheld power tool and to a side handle.

### BACKGROUND

Power tool units can have a side handle, for example for ease of use and/or withstanding torque from the power tool. The connection between the side handle and the power tool can be achieved via clamping, using a clamping band extending around the power tool.

U.S. Pat. No. 9,242,363 B1, for example, discloses a side handle for a handheld power tool, with the side handle being connected to the power tool via a band that is tightened around the housing of the power tool.

If a band is used for connecting the side handle, it might be necessary to reserve specific length of the tool for the side handle interface, potentially leading to longer tool length and less design freedom.

Other interface concepts can include clamps that engage two opposite surfaces provided on the power tool.

DE102014102904 A1, GB2165480 A, and U.S. Pat. No. 8,813,868 B2, for example, describe side handles with clamps that clamp designated clamping surfaces of the respective handheld power tools.

EP2292385 A2 discloses a handheld power tool with a side handle that has an integrated supply device, the side handle being threadedly connected.

US20050217440 A1 discloses an angular grinder with an adjustable side handle. The angular grinder has a support member which is pivotable relative to the housing of the angular grinder. The support member has slits on which the side handle is mounted.

US20120160531 A1 describes a handheld power tool with a hoop-shaped auxiliary handle connectable via a bayonet catch.

US20050200087 A1 discloses a handheld power tool having a quick connector, which comprises a bifurcated element which protrudes on the housing of the tool. Amongst others, a handle may be mounted to the quick connector.

### SUMMARY OF THE INVENTION

It is an object of the invention to provide a tool unit in which the side handle is connected to the power tool in a particularly reliable, easy to mount and/or dismount, and/or easy-to manufacture way, and which provides a particularly large degree of design freedom. It is also an object of the invention to provide corresponding power tools and/or side handles.

Accordingly, the invention encompasses a tool unit comprising a handheld power tool and a side handle mechanically connected to the power tool, wherein the side handle has a threaded rod, characterized in that

the power tool has an undercut groove delimited by a groove bottom, and

the side handle has a channel nut engaging the undercut groove, wherein the channel nut has a threaded hole,

wherein the threaded rod of the side handle is threadedly engaged in the threaded hole of the channel nut and acts, in particular axially, against the groove bottom of the undercut groove.

The present invention also provides a handheld power tool (1), preferably of a tool unit, having an undercut groove (30) for mounting a side handle (40), the undercut groove (30) being delimited by a groove bottom (35).

The present invention also provides side handle (40), having a threaded rod (43) and a channel nut (50) for engaging an undercut groove (30) of a handheld power tool (1), the channel nut (50) having a threaded hole (55), wherein the threaded rod (43) of the side handle (40) is threadedly engaged in the threaded hole (55) of the channel nut (50).

Thus, the power tool has a bottomed undercut groove, in which a channel nut provided on the side handle is received. The channel nut keys with the undercut groove, in particularly with its lips, so that the channel nut and the side handle are secured in a positively locking manner against being lifted laterally out of the undercut groove. The threaded rod is screwed through the channel nut so that it acts on the groove bottom of the undercut groove, thereby locking the channel nut and the side handle against displacement along the undercut groove. In particular, the threaded rod acting on the groove bottom presses the channel nut against the lips of the undercut groove, thereby locking the channel nut in the undercut groove. Thus, the channel nut mates and cooperates with the undercut groove so that it does not fall laterally out of the groove, and the channel nut is secured longitudinally in the groove by the threaded rod pressing on the undercut groove bottom.

The power tool can for example be a drill, a hammer drill, or a chisel tool. The side handle is preferably an elongate member, but it can also have more complex shapes. The threaded rod has an outer thread at least where it is screwed into the channel nut, but the threaded rod can also be threaded throughout. The threaded rod can have same diameter throughout or its diameter can vary, for example in a stepped manner. It can have circular or non-circular cross-sections. The respective threads of the threaded rod and/or of the threaded hole can be complete or interrupted, as long as they permit threaded engagement of the threaded rod in the channel nut.

The power tool can also have additional undercut grooves, potentially mating with the channel nut, which allows mounting the side handle in alternative configurations on the power tool. In particular, two distinct undercut grooves can be located on opposite sides of the power tool, in order to allow alternative left-handed or right-handed handle mounting.

The undercut groove is delimited at its bottom by the groove bottom. Preferably, it is delimited at its opposite lateral sides by the lips.

The threaded rod of the side handle is threadedly engaged in the threaded hole of the channel nut and acts against the groove bottom of the undercut groove, thereby locking the channel nut axially in the undercut groove. In other words, the threaded rod of the side handle is threadedly engaged in the threaded hole of the channel nut and presses, in particular axially with respect to the threaded rod, against the groove bottom of the undercut groove.

The undercut groove can for example be a T-groove. However, it is particularly preferred that the undercut groove is a dovetail groove. This type of groove is wider near the groove bottom that at its top, with a trapezoid cross-section. This design can be advantageous from the manufacturing, reliability, and/or usability point of view.

The channel nut preferably has a dovetail block. This allows particularly efficient mounting in a dovetail groove. The dovetail block cooperates with the undercut groove. In particular, the dovetail block has a right-cylindrical shape, with the base of the cylinder being a trapezoid

The undercut groove, in particular its longitudinal axis and/or the lips, are advantageously arranged parallel to the working axis of the power tool. This can provide that torque arising around the working axis is transferred to the side handle primarily via positive locking of the channel nut in the undercut groove, instead of via the threaded rod acting on the groove bottom, which can provide particularly efficient force transfer. Preferably, the longitudinal axis of the threaded rod of the side handle is perpendicular to the working axis of the power tool. Inserting the channel nut into the undercut groove can be from the front or back.

Expediently, the undercut groove delimits rotation of the channel nut around the threaded hole. In this case, the channel nut does not need to be manually fixed during screwing of the threaded rod. Therefore, this embodiment allows mounting and/or dismounting of the side handle in a particularly easy and efficient way. Delimiting rotation of the channel nut around the threaded hole can for example be achieved by making the undercut groove narrower than the maximum width of the channel nut, at least in regions, so that the channel nut locks against the side walls, i.e. the lips, of the undercut groove when it is attempted to rotate the channel nut around the threaded hole axis.

The side handle can have a gripping piece intended to be gripped by a user's hand when operating the power tool. This gripping piece can for example be roughly cylindrical, advantageously with a friction-improving coating.

Preferably, the threaded rod is connected to the gripping piece to rotate with gripping piece, in particular around the longitudinal axis of the threaded rod. In other words, threaded rod and gripping piece are rotationally fixed to each other, so that the threaded rod can be screwed into the threaded hole by rotating the gripping piece. Rotating the gripping piece after inserting the side handle's channel nut into the undercut channel will tighten the side handle. This embodiment can further facilitate mounting and/or dismounting of the side handle.

The power tool can comprise a housing. The undercut groove is preferably, at least partly, formed by the housing, i.e. at least some of the walls of the undercut groove are defined by the housing. Preferably, the undercut groove is wholly formed by the housing, i.e. all of the walls of the undercut groove are defined by the housing. This can for example further improve the manufacturing process.

The power tool preferably has a main handle. The side handle and the main handle are intended to be held by different hands of the user, respectively.

Preferably, the main handle is formed by the housing. This can further facilitate designing and manufacturing. The housing can encase a drive mechanism for actuating a tool bit, in particular an electric drive mechanism. More particularly, the housing can encase a drive shaft and a drive mechanism for driving the drive shaft.

According to another preferred embodiment of the invention, the channel nut has as a guiding collar for resting on the power tool in the vicinity of the undercut groove. The guiding collar is preferably located adjacent the dovetail block, so that channel nut grooves are formed between the dovetail block and the guiding collar, each channel nut groove receiving one of the lips of the undercut groove. This allows achieving a particularly robust and reliable design in a particularly easy manner.

The invention also relates to the handheld power tool of the tool unit. In particular the invention relates to a handheld power tool having an undercut groove for mounting a side handle, the undercut groove being delimited by a groove bottom.

Moreover, the invention also relates to the side handle of the tool unit. In particular the invention relates to a side handle having a threaded rod and a channel nut for engaging an undercut groove of a handheld power tool, the channel nut having a threaded hole, wherein the threaded rod of the side handle is threadedly engaged in the threaded hole of the channel nut.

### BRIEF DESCRIPTION OF THE DRAWINGS

The invention is explained in greater detail below with reference to preferred exemplary embodiments, which are depicted schematically in the accompanying drawings, wherein individual features of the exemplary embodiments presented below can be implemented either individually or in any combination within the scope of the present invention. Shown in the drawings are:

FIG. 1: A side view of an example of a tool unit comprising a handheld power tool and a side handle attached thereto.

FIG. 2: The power tool of FIG. 1, again in side view, but with the side handle removed.

FIG. 3: A perspective sectional view of the tool unit of FIG. 1, with the sectional plane running, perpendicular to the working axis of the power tool, through the neck of the housing of the power tool. The middle part and rear part of the housing of the power tool are depicted in a highly schematic manner only, for the sake of clarity.

FIG. 4: A perspective sectional view, having the same sectional plane as in FIG. 3, illustrating the mounting process of the side handle. Only the neck of the housing of the power tool is shown, whereas the middle part and rear part of the housing are now omitted for the sake of clarity. The gripping piece is shown as a transparent item.

FIG. 5: A partly sectional side view of the power tool of FIG. 1.

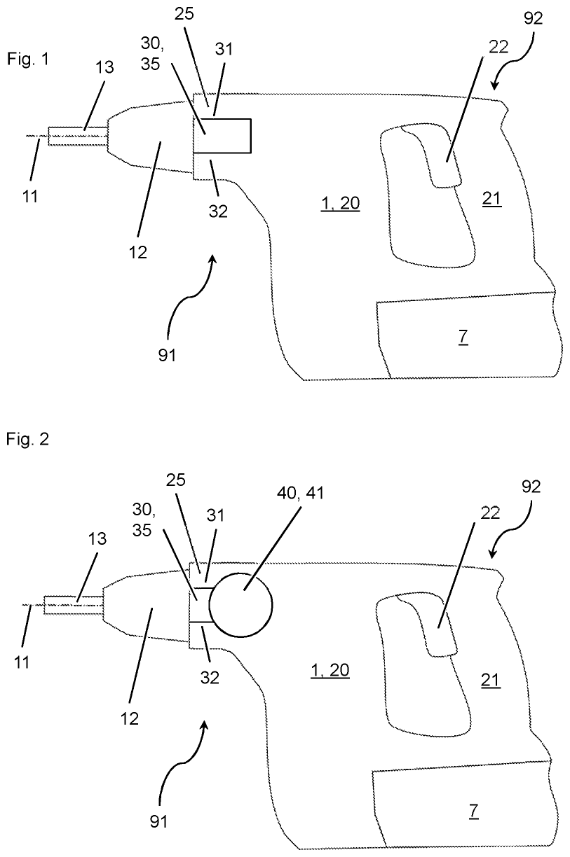

### DETAILED DESCRIPTION

The figures illustrate an example of a tool unit comprising a handheld power tool 1, which power tool is, by way of example, a percussion drill. The power tool 1 has a chuck 12, in which a tool bit 13, such as a drill bit or a chisel bit, is inserted and latched, such that the tool bit 13 is located coaxially to a working axis 11 of the power tool 1.

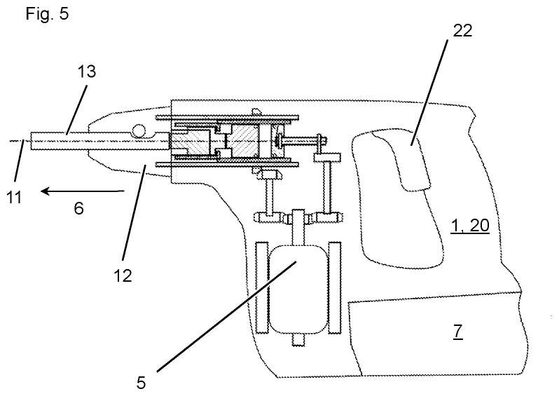

As shown in FIG. 5, the power tool 1 has a drive mechanism 5, which can rotate the chuck 12 and the tool bit 13 located therein around the working axis 11 and/or which can impact on the tool bit 13 in a direction of action 6, which direction of action 6 is parallel to the working axis 11 of the power tool 1. The power tool 1 has a housing 20, which encases the drive mechanism 5. The drive mechanism 5 is an electric drive mechanism 5 fed with electric power from a battery 7 attached to the housing 20, or/and, and not shown, with electric power from a power cable attached to the housing 20.

On the housing 20 is provided a main handle 21 for manually holding the power tool 1. The main handle 21 is intended to be held, in particular gripped around, by a holding hand of the user. In the shown embodiment, the main handle 21 is integral with the housing 20, but it can also be a separate part. In the vicinity of the main handle 21, or, as shown here, at the main handle 21 is provided an operation button 22. The operation button 22 is preferably arranged in such a way that the user can actuate it with the holding hand while the user is holding the main handle 21 with the holding hand. The drive mechanism 5 is operated when the operation button 22 is pressed.

The housing 20 extends in the direction of a working axis 11 from a front region 91 to a rear region 92 of the housing 20, wherein the front region 91 is directly adjacent to the chuck 12. In the front region 91, the housing 20 has a neck 25. In the present embodiment, the main handle 21 is in the rear region 92 of the housing 20, but it could also be arranged closer to the front region 91.

The tool unit moreover has a side handle 40 (see, e.g., FIG. 2). This side handle 40 is connected to the power tool 1, more specifically to the housing 20 thereof. The side handle 40 has a gripping piece 41, which gripping piece 41 is intended to be held, in particular gripped around, by the second hand of the user. The side handle 40 projects radially, with respect to the working axis 11, from the housing 20. The side handle 40 is connected to the housing 20 in the front region 91 of the housing 20, in particular it is connected to the housing 20 at the neck 25 of the housing 20.

By way of example, the gripping piece 41 is shown to have a cylindrical outer surface. But this is an example only, and it might for example also be designed bulbously or with a contour for the fingers. The gripping piece 41 can also have non-linear shapes, such as hook shapes or hoop shapes. The gripping piece 41 can consist of several components and/or layers. It is preferably encapsulated with an outer cover made of a soft foam material or elastomer.

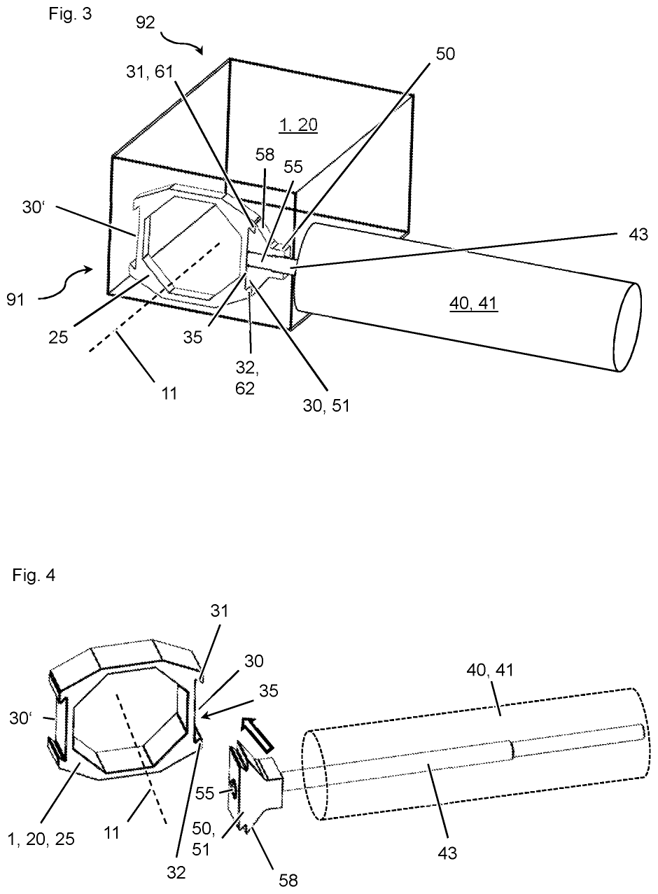

The housing 20 has a first undercut groove 30, on which the side handle 40 is attached to the housing 20. The first undercut groove 30 is provided on the left side of the housing 20. A second undercut groove 30′ (see, e.g, FIG. 3) is provided on the right side of the housing 20. This second undercut groove 30′ is for alternative mounting of the side handle 40 on the right side of the housing. Apart from the above, the first undercut groove 30 and the second undercut groove 30′ are configured alike. Therefore, and for the sake of brevity, only the first undercut groove 30 is described in detail in the following description. This description applies mutatis mutandis to the second undercut groove 30′.

In particular, the undercut groove 30 is provided in the neck 25 of the housing 20. At the undercut groove 30, the housing 20 has an elongate first lip 31 and an elongate second lip 32, wherein the first lip 31 and the second lip 32 face each other and delimit a slot, i.e. a narrow passage, into the undercut groove 30, wherein the slot is located between the first lip 31 and the second lip 32. The first lip 31 protrudes on the housing 20 towards the second lip 32 and the second lip 32 protrudes on the housing 20 towards the first lip 31. The first lip 31 and the second lip 32 are connected by a groove bottom 35, which is a surface of the housing 20. In the present embodiment, the groove bottom 35 is flat.

The first lip 31 and the second lip 32 each define an undercut, which allows mounting of add-on parts. In the present case, the undercut groove 30 is a dovetail groove, wherein “dovetail” can imply that the feature has non-rectangular, isosceles trapezoid cross-section. However, the undercut groove 30 could also be a T-groove, for example.

The lips 31, 32, the slot between the lips 31, 32 and the undercut groove 30 extend parallel to the working axis 11. At its front end, the undercut groove 30 has an open face for channel nut insertion. The rear face of the undercut groove 30 is closed, so a that channel nut cannot slip rearwardly out of the undercut groove 30.

The side handle 40 has a threaded rod 43, which projects from the gripping piece 41, and which is rotationally fixed to the gripping piece 41. In the present case, the threaded rod 43 is coaxially embedded in the gripping piece 41. The threaded rod 43 has an outer thread at least in its projecting portion, but it can also be threaded throughout.

The side handle 40 furthermore has a channel nut 50, having an element which is complementary to the undercut groove 30, and which engages the lips 31, 32 when the side handle 40 is mounted on the housing 20. In the shown embodiment, the element which is complementary to the undercut groove 30 is a dovetail block 51, wherein “dovetail” can again imply that the feature has non-rectangular, isosceles trapezoid cross-section. The channel nut 50 has a threaded hole 55, which threaded hole 55 is provided with an inner thread structure at least in regions. The threaded hole 55 is a through-hole, extending all the way through the channel nut.

The threaded rod 43 of the side handle 40 is screwed into the threaded hole 55 of the channel nut 50. When the side handle 40 is mounted on the housing 20, the threaded rod 43 is screwed so deeply into the threaded hole 55 that the threaded rod 43 projects over the bottom of the channel nut 50 and presses against the groove bottom 35, thereby locking the channel nut 50 and the attached gripping piece 41 in the direction of the working axis 11.

The process of mounting the side handle 40 on the housing 20 is illustrated in FIG. 4. First, the channel nut 50 threadedly attached to the threaded rod 43 is inserted into the undercut groove 30 at the front end of the undercut groove 30, and it is subsequently slid into the undercut groove 30 in the direction depicted by an arrow in FIG. 4. This is achieved by grabbing the gripping piece 41 connected to the channel nut 50 and by moving it appropriately. Subsequently, the gripping piece 41 is rotated relative to the power tool 1 in order to rotate the threaded rod 43 in the threaded hole 55 until the threaded rod 43 presses against the groove bottom 35, thereby pressing the dovetail block 51 against the lips 31 and 32, axially locking the channel nut 50 and the side handle 40 in the undercut groove 30. The channel nut 50, in particular its dovetail block 51, is so dimensioned that the channel nut 50 cannot rotate in the undercut groove 30 once it is inserted into the undercut groove 30. Therefore, the threaded rod 43 can be screwed into the threaded hole 55 without the need to manually hold the channel nut 50 in place.

As can be taken from FIGS. 3 and 4, the channel nut 50 can have a guiding collar 58 for resting on the housing 20 in the vicinity of the undercut groove 30, but outside of the undercut groove 30. In particular, the guiding collar 58 can be configure for resting on the lips 31, 32 of the housing. For the purpose of resting on the housing 20 in the vicinity of the undercut groove 30, the guiding collar 58 has guiding surfaces facing the housing 20. Between the guiding collar 58 and the dovetail block 51 are formed two channel nut grooves 61, 62, each receiving one of the lips 31, 32 of the undercut groove 30.

The guiding collar 58 can counteract jamming of the channel nut 50 within the undercut groove 30 and/or improve ergonomic properties.

1-12. (canceled)

13. A tool unit comprising:
a handheld power tool having an undercut groove delimited by a groove bottom; and
a side handle mechanically connected to the power tool, the side handle having a threaded rod and having a channel nut engaging the undercut groove, the channel nut having a threaded hole, the threaded rod threadedly engaged in the threaded hole of the channel nut and acting against the groove bottom of the undercut groove.

14. The tool unit as recited in claim 13 wherein the undercut groove is a dovetail groove.

15. The tool unit as recited in claim 14 wherein the channel nut has a dovetail block.

16. The tool unit as recited in claim 13 wherein the undercut groove is arranged parallel to a working axis of the power tool.

17. The tool unit as recited in claim 13 wherein the undercut groove delimits rotation of the channel nut around the threaded hole.

18. The tool unit as recited in claim 13 wherein the side handle has a grip to be gripped by a user hand when operating the power tool, the threaded rod being connected to the grip to rotate with grip around a longitudinal axis of the threaded rod.

19. The tool unit as recited in claim 13 wherein the power tool includes a housing, the undercut groove being, at least partly, formed by the housing.

20. The tool unit as recited in claim 19 wherein the power tool has a main handle, wherein the main handle being formed by the housing.

21. The tool unit as recited in claim 19 wherein the housing encases a drive mechanism for actuating a tool bit.

22. The tool unit as recited in claim 13 wherein the channel nut has a guiding collar for resting on the power tool in a vicinity of the undercut groove.

23. A handheld power tool comprising an undercut groove for mounting a side handle, the under-cut groove being delimited by a groove bottom.

24. A side handle comprising a threaded rod and a channel nut for engaging an undercut groove of a handheld power tool, the channel nut having a threaded hole, the threaded rod being threadedly engaged in the threaded hole of the channel nut.
